(19) United States
(12) Patent Application Publication
(10) Pub. No.: US 2019/0111649 A1
(43) Pub. Date: Apr. 18, 2019

(54) Robotic End-of-Arm Tool for Case Erecting

(71) Applicant: Pearson Packaging Systems, Spokane, WA (US)

(72) Inventor: Michael James Johnson, Spokane, WA (US)

(73) Assignee: Pearson Packaging Systems

(21) Appl. No.: 16/160,842

(22) Filed: Oct. 15, 2018

Related U.S. Application Data
(60) Provisional application No. 62/572,947, filed on Oct. 16, 2017.

(51) Int. Cl. B31B 50/00; B25J 11/00; B25J 9/00; B65B 43/26; B65B 5/02

(52) U.S. Cl. CPC B31B 50/006; B25J 11/005; B31B 50/30; B65B 43/265; B65B 5/024; B25J 9/0087

(57) ABSTRACT

Structure, method and techniques for a robotic end-of-arm tool usable in the packaging industry are described herein. In an example, the end-of-arm tool is configured for attachment to a robotic arm, and may be used in case opening and sealing operations. The case may be partially opened by a packaging system from a folded-flat configuration, and may be and squared and sealed by the end-of-arm tool. In the example, first and second mandrels (or jigs) are configured to be extended to contact inside surfaces of a case. In the example, a base supports the first and second mandrels, and allows adjustment of a distance by which they are separated. In an extended state, the mandrels press on interior surfaces of opposite sides of the case, forming the case into a square configuration. Suction cups hold the minor flaps, allowing the major flaps to be folded and sealed.

### RELATED APPLICATIONS

This patent application claims priority to U.S. patent application Ser. No. 62/572,947, titled “Robotic End-of-Arm Tool for Case Erecting,” filed on 16 Oct. 2017, commonly assigned herewith, and hereby incorporated by reference.

### BACKGROUND

Case erecting machinery is known in the packaging industry. A case erecting machine may be configured as part of a packaging line or as a robotic tool. Such machinery erects and assembles cases, adds merchandise, and seals the case. An assembly line wherein each case is the same size, and filled with the same product, can be configured to operate with substantial speed. However, when changes in case size and/or contents are required in a single packaging line, substantial technical issues may arise. Robotic tools are able to address many of these issues. However, many issues are still unresolved, including the need to precisely fold and seal flaps of the case, the need to use different case-sealing techniques, the need to accommodate different product items in the packaging process, and the need to adjust to many case sizes.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components. Moreover, the figures are intended to illustrate general concepts, and not to indicate required and/or necessary elements.

FIG. 1 is an orthographic view of portions of a robotic arm and an end-of-arm tool, showing an adjustable mandrel in a retracted position or state, wherein first and second portions of the mandrel are in contact or only slightly separated.

FIG. 2 is a perspective view of the end-of-arm tool, showing the first and second portions of the mandrel in the retracted position or state. The retracted position is associated with inserting the tool into a case and retracting it from the case.

FIG. 3 is an orthographic view of portions of the robotic arm and end-of-arm tool, showing the adjustable mandrel in an extended position or state, wherein first and second portions of the mandrel are separated. The extended position is associated with contacting inside surfaces of the case to fully open and square the case.

FIG. 4 is a perspective view of the end-of-arm tool, showing an example mechanism to control spacing between the first and second portions of the mandrel, and showing an example suction cup configuration. Control over the spacing between a first and second mandrel allows adaptation to cases of different sizes.

FIGS. 5 through 10 show an example sequence of events.

FIG. 5 is a perspective view of the end-of-arm tool, showing the first and second portions of the mandrel in close contact with each other, and in the process of being inserted into a partially erected case.

FIG. 6 is a perspective view of the end-of-arm tool, showing the first and second mandrels further inserted into the case.

FIG. 7 is a perspective view of the end-of-arm tool, showing the end-of-arm tool substantially inserted into the case, and showing the first and second portions of the mandrel expanding within the case, to position the first mandrel (or a first portion of the first mandrel) adjacent to an inside surface of a first side of the case and to position the second mandrel adjacent to an inside surface of a second side of the case.

FIG. 8 is an orthographic view, having a cut-away of the case, showing the first and second portions of the mandrel expanded to contact inside surfaces of the case, respectively. The first and second minor flaps have been folded, and are held in place by first and second suction cups of the first and second portions of the mandrel, respectively.

FIG. 9 is a perspective view, taken from below the case, showing of the end-of-arm tool, having expanded within the case to contact inside surfaces of opposed case walls, and having attached the suction cups to the minor flaps, which are in a closed position.

FIG. 10 is a perspective view showing of the end-of-arm tool, having attached the suction cups to the minor flaps of the case, while the major flaps are partially closed after contact with a plow (the plow not shown for clarity).

FIG. 11 is a perspective view of the end-of-arm tool and portions of a robotic arm, showing an optional configuration, wherein the first and second portions of the mandrel are configured to grasp a product item, and to thereby assist to open the case, square the case, and deliver at least one product item.

FIGS. 12A and 12B are a flow diagram, showing example operation of a robotic end-of-arm tool for case erecting.

### DETAILED DESCRIPTION

### Overview

The disclosure describes techniques for opening and sealing cases in an automated packaging system. More particularly, the disclosure describes use of a robotic end-of-arm tool to fully open cases in a square manner with 90-degree corners. In an example, a robotic arm and an associated end-of-arm tool are inserted into a partially open case. The tool then squares the case and seals lower flaps. The case may then be filled with product, and the upper flaps sealed. In the example, the end-of-arm tool may be configured with first and second mandrels that may be retracted (i.e., moved to a retracted state) for insertion into, and/or withdrawal from, a case. The first and second mandrels may also be extended (i.e., moved to an extended state) when inside the case to contact inside surfaces of a case. In the example, the first and second mandrels may be extended to press against inside surfaces of opposed minor sides of the case, thereby creating a 90-degree relationship between all adjacent sides of the case. While minor sides (the small side of a rectangular case) traditionally are the leading and trailing sides of the case as it moves on a conveyor line, this could be reversed, and the techniques disclosed herein are adapted to any orientation. As a step in a process to close the bottom flaps of the case, the minor flaps may be folded by movement of the robotic arm and end-of-arm tool, which may press each minor flap against a surface to make a 90-degree fold. Once folded, each minor flap is held in place against suction cups carried by the first and second mandrels, respectively. With the first and second minor flaps secured, the end-of-arm tool may manipulate the case in any desired manner and/or orientation to close the major flaps. In an example, the end-of-arm tool (moved by the robotic arm) may press the major flaps against a plow, to fold them 90-degrees. Once folded, the major flaps may be sealed, such as by moving them against a tape-head. Alternatively, glue may be applied to the minor flaps (or major flaps) before the major flaps are folded against the minor flaps. After the fold, the major flaps may be pressed against a flat surface, thereby spreading the glue and making the seal. Once the bottom flaps are sealed, suction cups may be released, and the first and second mandrels of the end-of-arm tool may be moved closer together (i.e., into the retracted state) so that they no longer contact inside surfaces of the case. The end-of-arm tool may then be withdrawn from the case, which may be left in a prescribed location within a conveyor and/or packaging system.

### Example System and Techniques

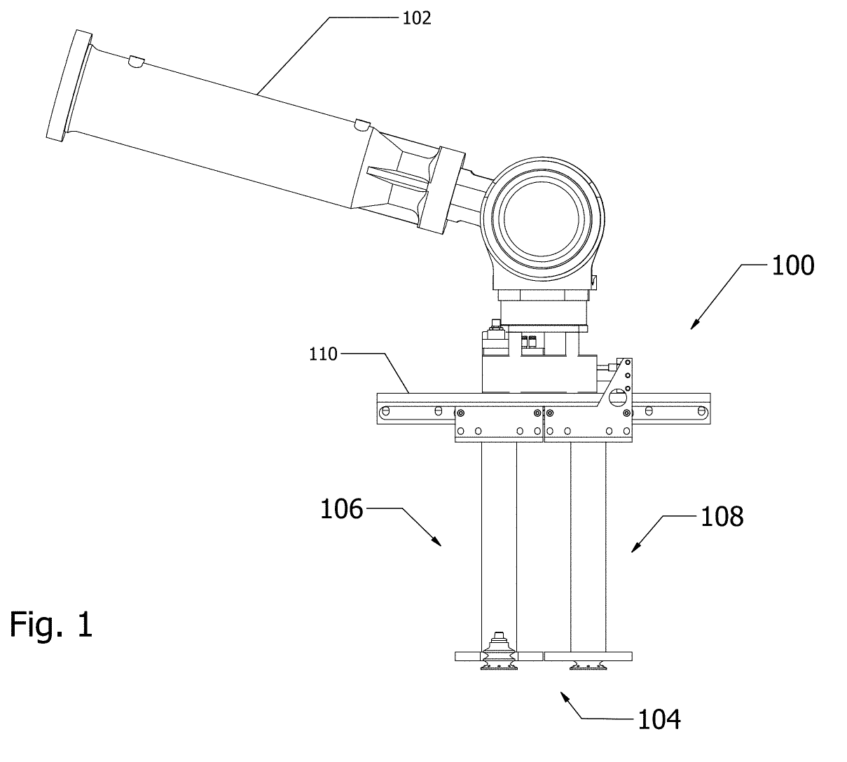

FIG. 1 shows portions of an end-of-arm tool 100 supported by a robotic arm 102 (shown in part). In the example shown, the end-of-arm tool 100 includes an adjustable mandrel 104 having a compound structure. The term “mandrel” is used to indicate a tool that holds and/or positions a work item (e.g., a case) while it is assembled, folded, sealed, etc. In some instances, the term “jig” or other terms could alternatively be used to describe such a tool that used to form, assemble, fold, seal, etc., a case or other work product. The mandrel described herein may be viewed as a single complex mandrel, which may have two portions that move to hold opposite sides of a case. Using alternative terminology, a tool or jig may be considered to have two mandrels or two jigs, one of which contacts inner surfaces of opposite sides of the case. In the example, the compound structure includes first and second mandrels 106, 108 (or portions 106, 108 of a single mandrel). The first and second mandrels are supported by, and/or positioned along, a base 110. In a retracted position or state, the first and second mandrels have moved on a track of the base 110 into a retracted position or state, and are therefore in contact, or nearly in contact, with each other. The “track” on the base 110 may include rod(s) with bearing(s) sliding over them, or any other design as indicated by requirements. In the retracted state, the first and second mandrels are more easily inserted into a partially or fully opened case. The extended state is sized to allow the mandrels, already inserted within the case, to move adjacent sides of the case into 90-degree or “square” relationships, such as for flap folding, taping and/or gluing, etc. Cases (e.g., cardboard boxes) are frequently sold in stacks of boxes, each in a folded-flat configuration. Accordingly, before receiving product, each case is erected (opened) and the bottom minor flaps, and major flaps, folded and/or sealed.

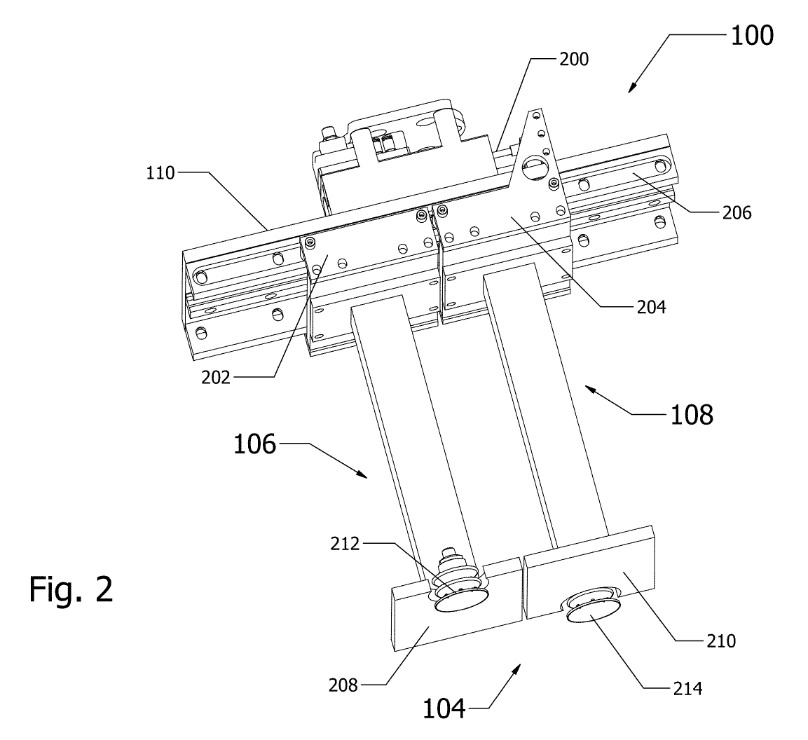

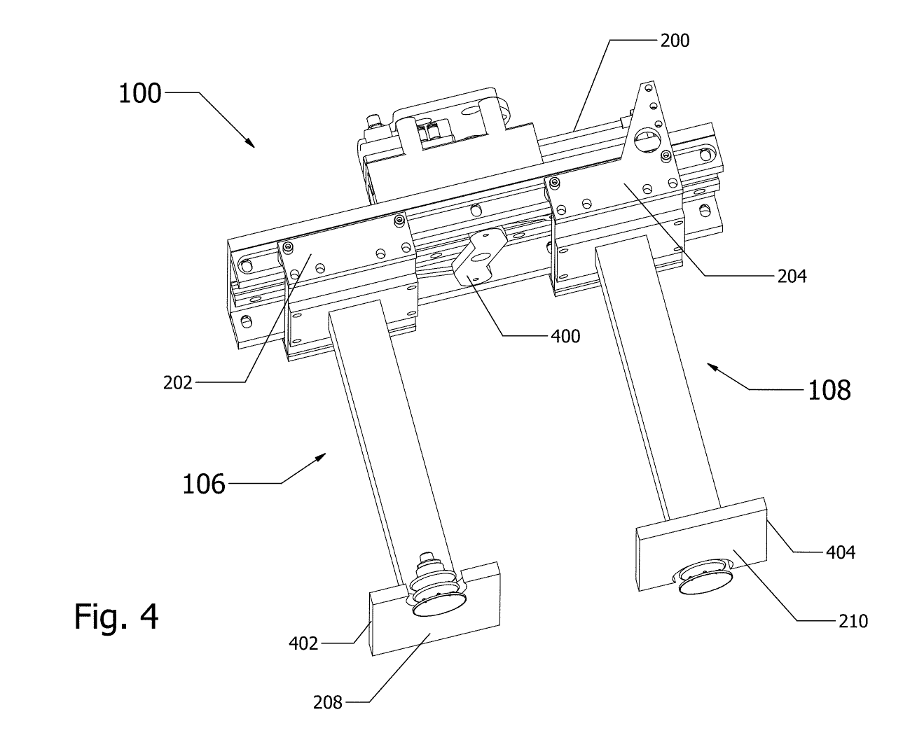

FIG. 2 shows an alternative viewing angle of the end-of-arm tool 100 in a retracted state that is similar to FIG. 1. The end-of-arm tool 100 includes the first portion 106 (or first mandrel 106) and second portion 108 (or second mandrel 108) of the compound mandrel 104. In the view shown, the mandrels 106, 108 are in the retracted position or state. An actuator 200 has retracted, causing a linkage (seen in the view of FIG. 4) to pull the mandrels 106, 108 together. In the example shown, the actuator 200 has caused the first and second carriages 202, 204 associated with the first and second mandrels 106, 108, to move together on a track 206 of the base 110. The movement of the carriages, and associated mandrels, may be made in a unified manner, driven by the single actuator and a linkage that transmits power to each carriage. The carriages 202, 204 may be moved on the track 206 by servo motors, compressed air cylinders, a mechanical linkage, or other means as indicated by design requirements. In the example shown, the actuator 200 may be operated by a compressed air cylinder. Also in the example shown, each mandrel 106, 108 includes a plate 208, 210. One or more suction cups 212, 214 may be carried by each plate 208, 210. The suction cups may be used to releasably attach to opposed flaps (e.g., opposed minor flaps) of a case, and to hold the flaps at a 90-degree angle with respect to the case side to which they are respectively attached. Holding the minor flaps at 90-degrees allows the major flaps to be folded against the minor flaps, and then sealed (taped, glued, etc.) in place. Accordingly, by holding two flaps of an open end of a case in a prescribed position (e.g., the position that they would be if the case was closed), the four sidewalls of the case are moved into 90-degree relationships.

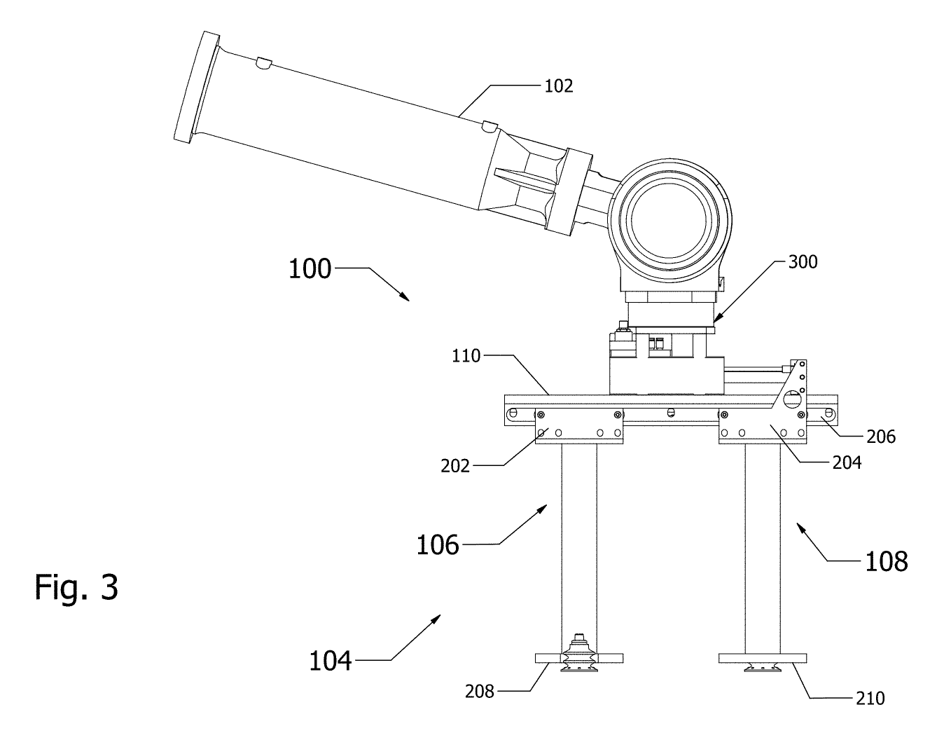

FIG. 3 shows the end-of-arm tool 100 and portions of the robotic arm 102. An attachment point 300 allows connection between the end-of-arm tool 100 and the robotic arm 102. The view shows the adjustable compound mandrel 104 in an extended position or state. In the extended state, movement by the first and second carriages 202, 204 along the track 206 of the base 110 have separated the first mandrel 106 and the second mandrel 108. The extended state may be utilized in the case erecting process, wherein the mandrels 106, 108 are separated by an amount based at least in part on a size of a case into which the end-of-arm tool 100 has been inserted. For example, the mandrels 106, 108 may be separated by a distance that causes the plates 208, 210 to contact inside surfaces of the case, and cause the case to assume a square configuration with all case sides at 90-degrees with respect to adjacent sides.

A comparison of FIGS. 1 and 3 shows that the mandrel 104 may have two component mandrels 106, 108 that are adjustable. However, in a further example, the mandrel 104 may be fixed-size. A fixed-size mandrel could be sized and configured to fit into an erected, or nearly erected, case. Such a mandrel could be considered to be a “loose fit,” in that the “tighter fit” obtained by an expandable mandrel may not be attained. Additionally, such a mandrel would not be adapted (as is a size-adjustable mandrel) for use with cases of multiple sizes. However, such a fixed-size mandrel could secure opposed flaps of the case with suction cups or other means, in a manner similar to the mandrel described herein. Additionally, such a mandrel could provide contact with all four sides of a case, rather than two opposed sides (e.g., both minor sides of the case). Accordingly, this disclosure includes fixed-size mandrels and adjustable-sized mandrels. A mandrel without carriages, but otherwise similar to FIGS. 1 through 4, describe a fixed-size mandrel. Such a mandrel may be lower in cost, and well-suited to use in a single case-size environment. An end-of-arm tool having such a mandrel offers the significant advantage also seen in the adjustable mandrel, namely that suction cups configured to grasp the case under construction allow the case to be modified (e.g., flaps plowed and/or sealed), such as by movement and operation of the robotic arm. Accordingly, both size-adjustable and size non-adjustable mandrels are shown and described by the drawings and text, and it is expressly stated that a fixed size end-of-arm tool is taught, such as by construction without a track, carriages, actuator, linkage, etc.

A comparison of FIGS. 1 and 3 shows the compound mandrel 104 expanding in a first direction, so that portions of each mandrel 106, 108 contact an inside surface of two respective opposed sides of a case. In a further example, a compound mandrel could be configured to expand to contact inside surfaces of all four sides of a case, rather than just two. The compound mandrel may have four mandrel-components, and may require several tracks to allow expansion and contraction of the mandrel components. Such a mandrel may provide some benefits in some circumstances, such as with larger cases.

FIG. 4 shows an alternative viewing angle of an end-of-arm tool 100 that is similar to the end-of-arm tool of FIG. 3, and that is shown in the extended state. Extension of the actuator 200, and movement of the linkage 400, have caused the carriages 202, 204 to separate the mandrels 106, 108. The linkage 400 causes the carriages 202, 204 to move in unison, and also allows a single actuator 200 to move both carriages. Also, while a compressed-air-powered actuator 200 and a mechanical linkage 400 are shown, alternative power sources could be used. Accordingly, the plates 208, 210 have separated by a distance required to put an edge surface 402, 404 of each plate against an inside surface of a case, and to cause that case to assume a “square” (i.e., adjacent sides at 90-degree relationships) configuration.

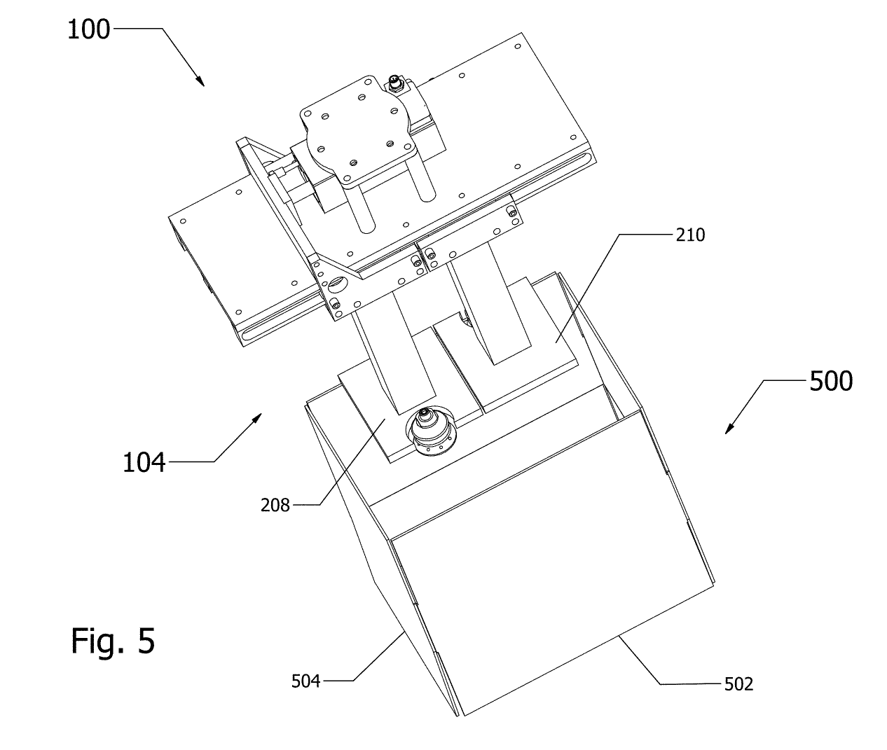

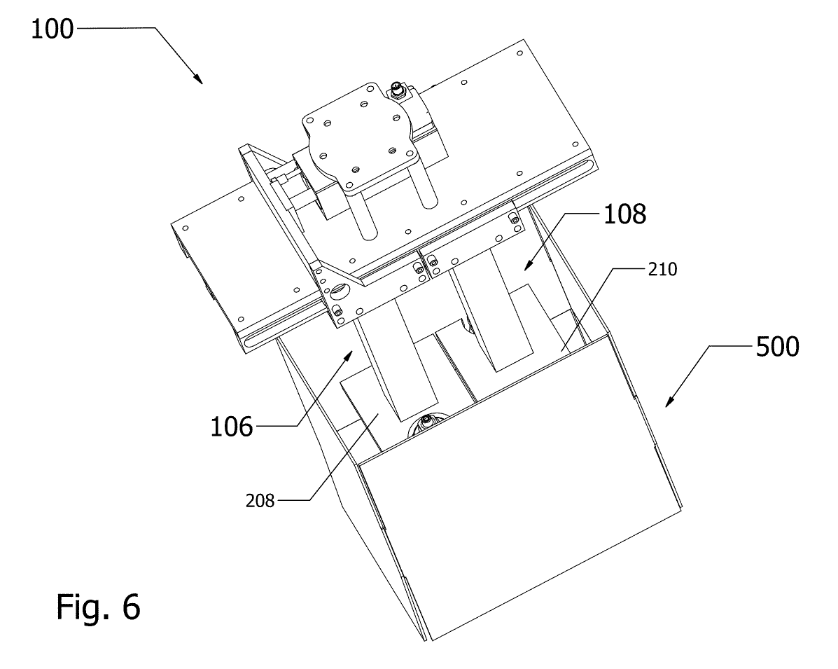

FIG. 5 shows the end-of-arm tool 100, showing the first and second plates 208, 210 of the mandrel 104 in close proximity to each other, and in the process of being inserted into a partially erected case 500. By putting the mandrel 104 in the retracted position, the mandrel is more easily inserted into the case. The case 500 includes a major flap 502 and a minor flap 504. Minor flaps are on the short side of a rectangular case and are closed before the major flaps are closed. After the major flaps are closed, they can be sealed with tape. Alternatively, glue can be applied to the outside surface of the minor flaps and/or the inside surface of the major flaps before the major flaps are closed.

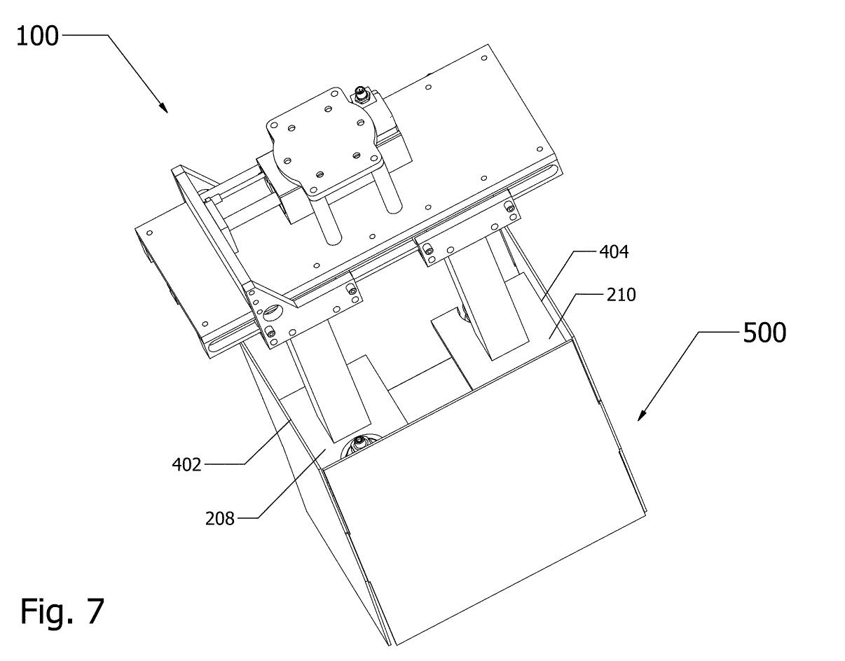

FIG. 6 shows the first and second mandrels 106, 108 further inserted into the case 500. The end-of-arm tool 100 is inserted into the case 500 until the lower surface of the plates 208, 210 are approximately adjacent to the fold lines of the lower major and minor flaps. Accordingly, when the minor flaps are bent at 90-degrees, they will contact the bottom surfaces of the plates 208, 210 and be secured by the suction cups.

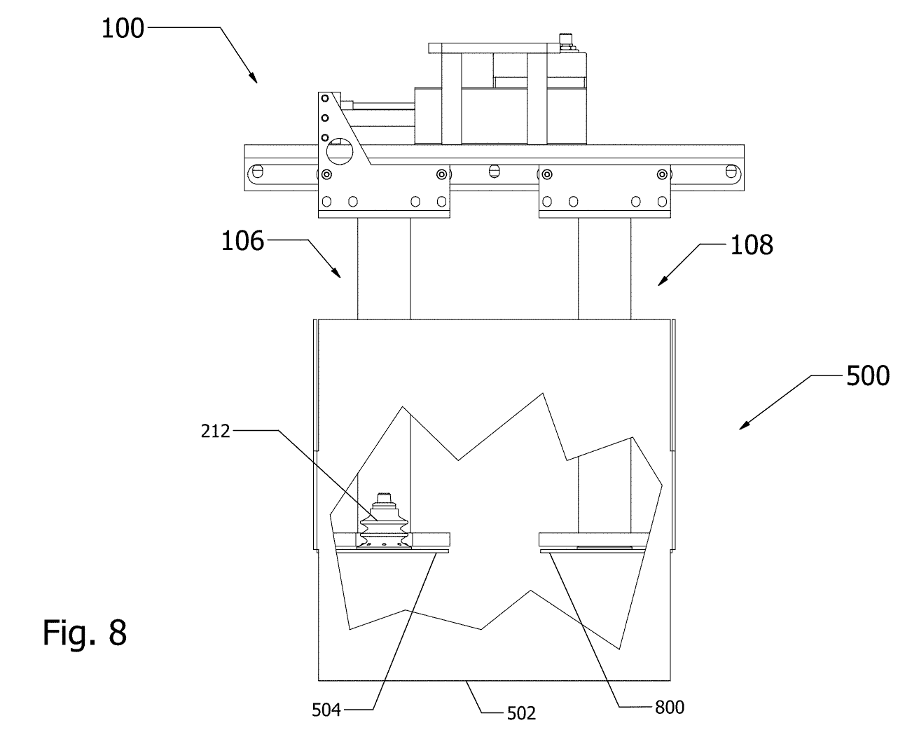

FIG. 7 shows the end-of-arm tool 100 that has been substantially inserted into a case. The first and second mandrels have moved to an extended state within the case, so that the edges 402, 404 of the plates 208, 210 are forcing the side panels of the case 500 to be at a 90-degree relationship with adjacent side panels. The minor flaps have not yet been folded.

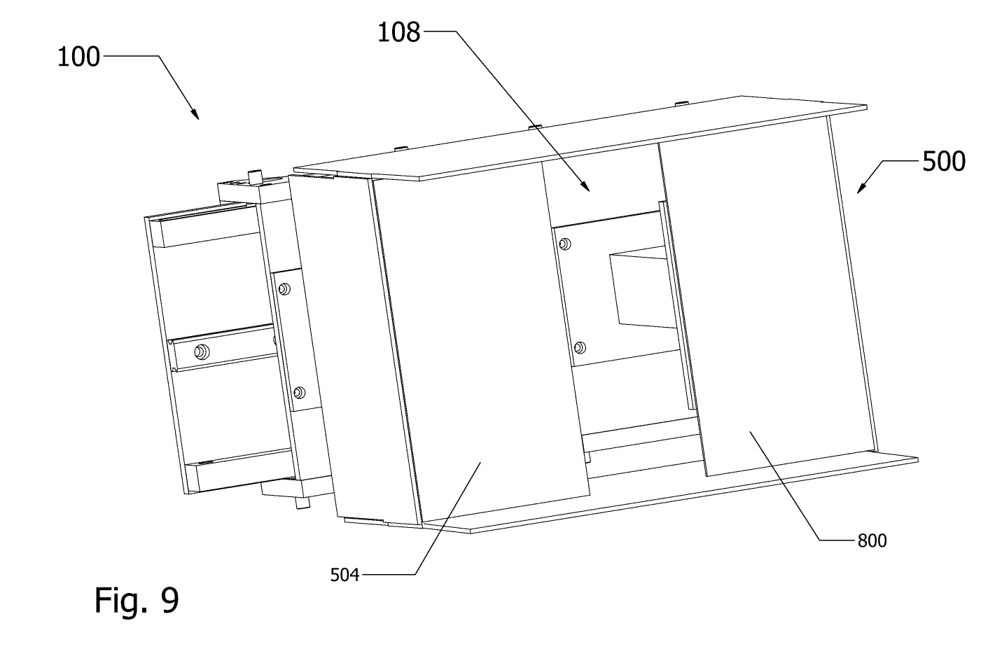

FIG. 8 shows a cut-away of the case 500. The mandrels 106, 108 have separated by a distance sufficient to locate the plates on inside surfaces of the minor case panels. The minor flaps 504, 800 have been folded at 90-degrees, and have been secured by the suctions cups 212, (214 not shown in this view). The major flap 502 (and a similar flap on the opposite side of the case, not shown) have not yet been folded.

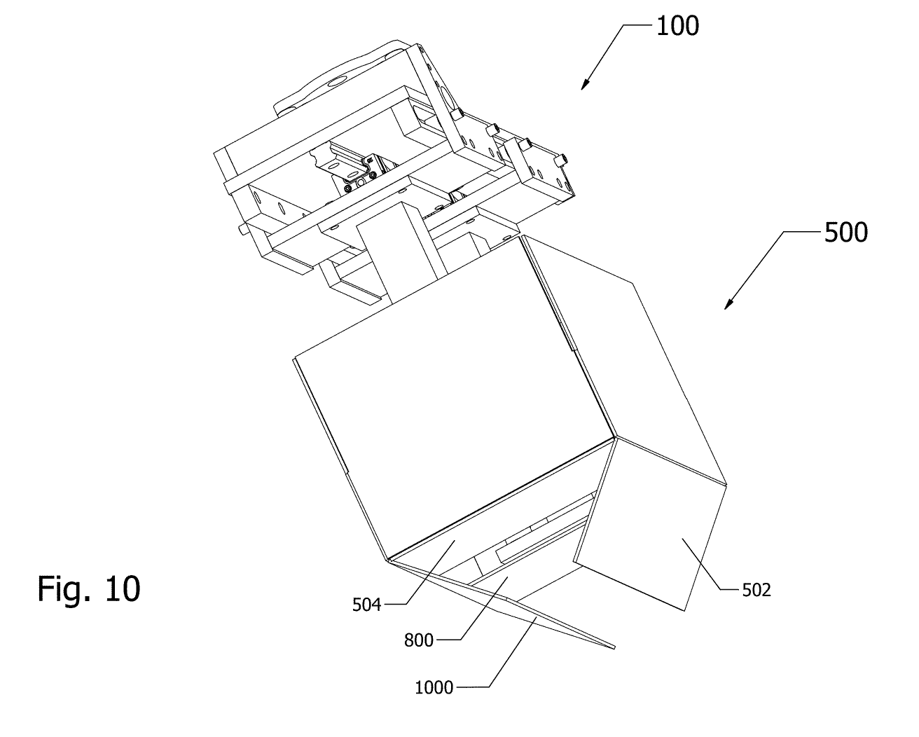

FIG. 9 shows a different view of the circumstances shown in FIG. 8. The minor flaps 504, 800 are held in a closed position by the suction cups (not shown). The major flaps have not yet been folded.

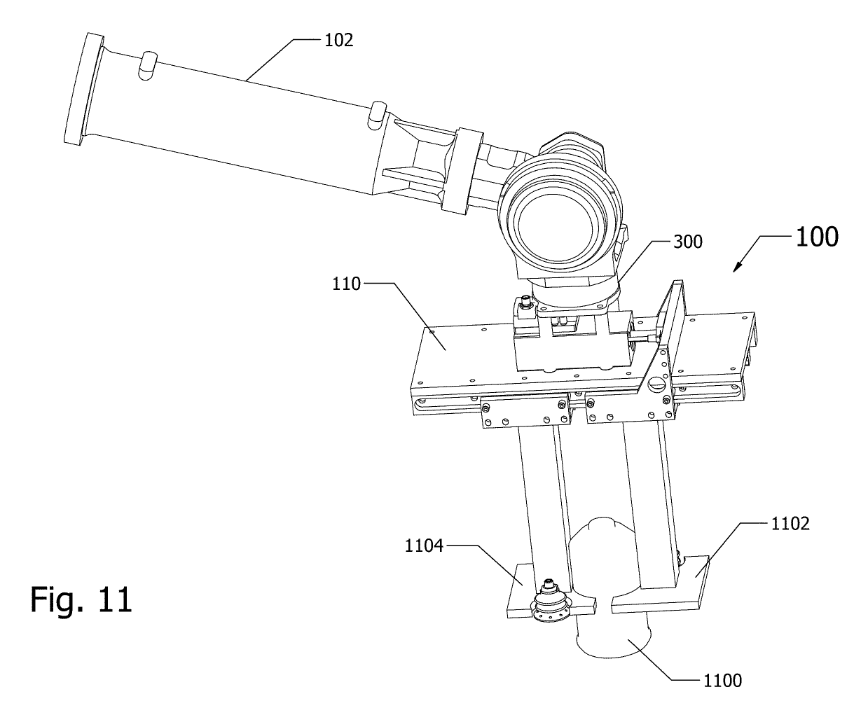

FIG. 10 shows the end-of-arm tool 100 and case 500. The minor flaps 504, 800 continue to be held in a closed position by suction cups of the end-of-arm tool 100. The major flaps 502, 1000 are partially closed after contact with plows (not shown for clarity). The plows may be in fixed locations or moveable. If the plows are fixed, the end-of-arm tool 100 moves the case to the plows, which close the major flaps. If the plows move, the end-of-arm tool 100 may be fixed or may also move. The major flaps 502, 1000 may be fully closed by additional contact of the major flaps with the plows. During or after the closing of the major flaps, the major flaps may be sealed by operation of a tape head. Alternatively, if glue was applied to the outer surface of the minor flaps and/or the inner surface of the major flaps, the end-of-arm tool 100 may press the major flaps against a flat surface to squeeze and spread the glue, and to fully close and seal the flaps.

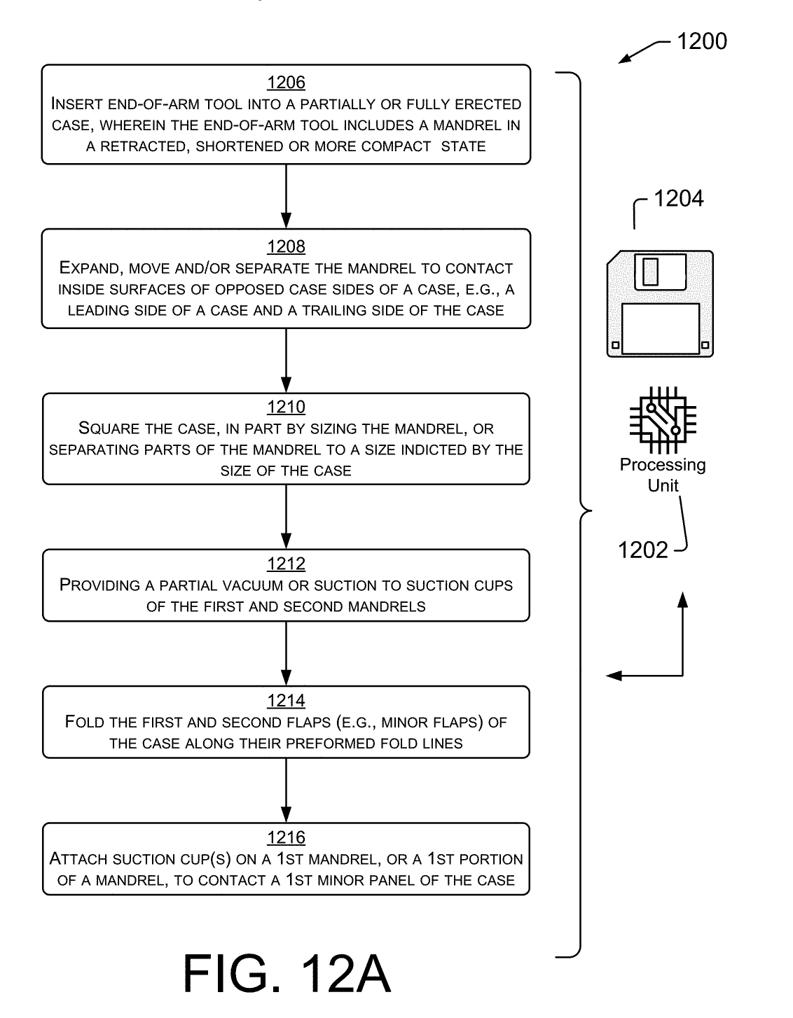

FIG. 11 shows an example end-of-arm tool 100, portions of a robotic arm 102 and a connector 300 between them. In this example configuration, plates 1102, 1104 of the mandrel are configured to grasp a product item 1100. Thus, the plates can assist to open the case, to square the case, and to deliver at least one product item.

### Example Methods

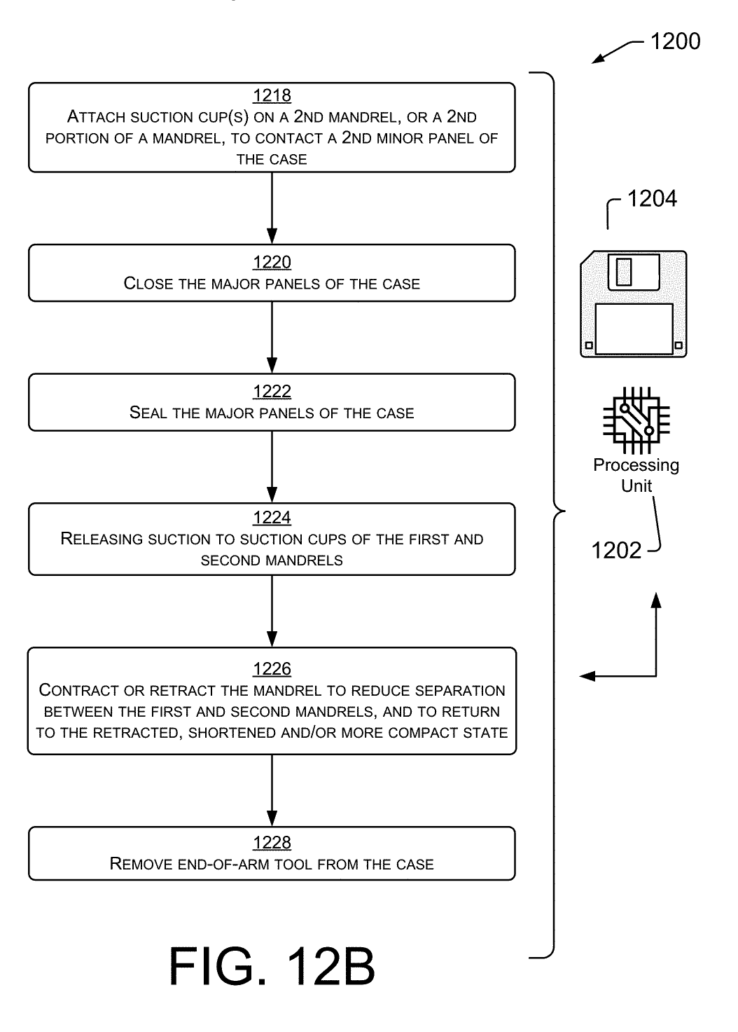

FIG. 12 shows example method(s) 1200 and example operation of a robotic end-of-arm tool for case erecting. The methods 1200 refer to a mandrel or a jig, which are used interchangeably to indicate a portion of a tool (e.g., an end-of-arm tool of a robotic arm) that holds a piece of work, such as a case to be assembled, and allows tools such as flap plows, glue guns, tape heads, etc., to be used on the case.

In some examples of the techniques discusses herein, the methods of operation may be performed at least in part by actions of one or more processors 1202. The processors may include one or more of an application specific integrated circuits (ASIC) or a general-purpose processor utilizing software defined in computer readable media and/or memory device 1204. In the examples and techniques discussed herein, the memory device 1204 may comprise computer-readable media and may take the form of volatile memory, such as random-access memory (RAM) and/or non-volatile memory, such as read only memory (ROM) or flash RAM. Computer-readable media devices include volatile and non-volatile, removable and non-removable media implemented in any method or technology for storage of information such as computer-readable instructions, data structures, program modules, or other data for execution by one or more processors of a computing device. Examples of computer-readable media include, but are not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device.

As defined herein, computer-readable media device 1204 does not include transitory media, such as modulated data signals and carrier waves, and/or signals.

At block 1206, an end-of-arm tool is inserted into a partially or fully erected case. The end-of-arm tool may include a mandrel (or jig) in a retracted, shortened or more compact state. Referring to the example of FIGS. 5 and 6, the end-of-arm tool 100 includes an adjustable, compound mandrel 104. The mandrel may be a tool for working on, assembling, squaring, closing, sealing bottom flaps, loading/filling, sealing top flaps, and/or otherwise processing a case. The compound mandrel 104 may be configured as two mandrels 106, 108, each having a plate 208, 210 or similar structure for contacting opposed inside surfaces of a case. With the mandrels 106, 108 in the retracted position seen in FIG. 5, they fit into the partially assembled case 500, as seen in FIG. 6.

At block 1208, the mandrel, mandrels and/or portions thereof expand, separate and/or extend to contact an inside surface of a leading side of a case and to contact an inside surface of a trailing side of the case. In an example, the two parts of a compound mandrel separate, allowing each to press on an inside surface of opposed sides (e.g., leading and trailing sides, which are usually minor i.e., shorter sides) of the case. The expansion or separation of block 1208 is seen by comparison of FIG. 6 (with the mandrels in compact form) and FIG. 7 (with the mandrels in expanded form, to contact inside surfaces of the case).

At block 1210, the pressure applied by the mandrels “squares” the case, causing adjacent panels of the case to assume relative orientations of 90-degrees. Referring to the example of FIG. 8, the end-of-arm tool 100 has been inserted to the point where the bottom of the plates 208, 210 are in the same plane as the fold lines of the major and minor flaps. The plates 208, 210 of the mandrel have extended to contact inner surfaces of opposed minor panels of the case 500.

At block 1212, a partial vacuum or suction is provided to one or more suction cups on each of the portions of the mandrel. The suction cups will grasp and hold flaps of the case after they are folded into placed. The “flaps” are portions of the case that form the bottom and top of the case, and are glued or taped in the case-sealing process.

At block 1214, the first and second flaps of the case (e.g., the first and second minor flaps) are folded along preformed fold lines. The fold may orient each flap at approximately 90-degrees to the side of the case to which the flap is attached. The minor panels may be closed by action of the robotic arm and end-of-arm tool, such as by moving the tool to contact the minor panels of the case with a plow to bend the flap panels at their respective fold lines, and to close both minor panels. Note that there are significant advantages to closing the minor flaps before closing the major flaps. However, this ordering could be reversed. Also note that the order of blocks 1212 and 1214 are performed may vary in some systems.

At block 1216 and 1218, the minor flaps, having been folded at approximately 90-degrees on their fold-lines, are attached to one or more suction cups of respective mandrels. The fold of each minor flap may be made by the robotic arm and end-of-arm tool manipulating the case, to press each minor flap against a plow or other surface (singly, or in unison) and fold each flap at its respective preformed fold-line or crease. The plow may be fixed or mobile. Once folded, the minor flaps are locked into place by their respective suction cups. Referring to the example of FIG. 8, both minor flaps are shown attached to suction cups of respective mandrels. Once attached, the minor flaps are out of the way of subsequent operations to close the major flaps.

At blocks 1220 and 1222, the third and fourth flaps (e.g., the major flaps) of the case are closed and sealed. In the example of FIG. 10, the minor flaps are held in position by suction cups, allowing the robotic arm to move the case as desired. In the view of FIG. 10, the major flaps are shown in a partially closed state. The major flaps can be closed partly or fully by moving the major flaps of the case against plow(s), which fold the major flaps at their preformed fold-line or crease. If the major flaps are to be glued to the minor flaps, the closed major flaps may be pressed against a flat surface to spread and set up the glue.

At block 1224, the partial vacuum or suction on the suction cups is released. This allows the portions of the compound mandrel to move with respect to each other, and for the mandrel to be removed from the case.

At block 1226, the compound mandrel is contracted, or two mandrels are moved together into the retracted, shortened or more compact stat. Thus, pressure against, and/or contact with, the inside surface of the case is discontinued. Thus, the compound mandrel moves from the configuration shown in FIG. 7 to the configuration shown in FIG. 6.

At block 1228, the end-of-arm tool is removed from the case. This may appear initially as seen in FIG. 6, and as seen in FIG. 5 as the tool is removed from the case. Removal of the tool 100 releases the case, which could be left in a prescribed location within the system. The location may be on a conveyor, and/or a location within a system at which the case, with the bottom of the case sealed, may be filled with merchandise. The top of the case may then be sealed.

### Example Structure and Operation

Example structure and operation of a robotic end-of-arm tool for case erecting are described. In a first example, an end-of-arm tool, includes: a mandrel, comprising: a first portion; and a second portion; a base to which the first portion of the mandrel and the second portion of the mandrel are attached in an adjustable manner to allow a distance between the first portion of the mandrel and the second portion of the mandrel to be adjusted; and an attachment point. In an example, of the end-of-arm tool the attachment point is configured to allow connection to a robotic arm. In an example of the end-of-arm tool, the distance between the first portion of the mandrel and the second portion of the mandrel is adjustable to allow the first portion of the mandrel to contact an inside surface of a first side of a case, and to allow the second portion of the mandrel to contact an inside surface of a second side of the case. In an example, the end-of-arm tool additionally includes: at least one suction cup carried by each of the first portion of the mandrel and the second portion of the mandrel. In an example, the end-of-arm tool additionally includes: a linkage, connecting the first portion of the mandrel and the second portion of the mandrel, to move the first portion of the mandrel and the second portion of the mandrel in a unified manner. In an example, the end-of-arm, additionally includes programming defined in one or more memory devices, to control operation of the end-of-arm tool, wherein the programming is configured for: moving and separating the first portion of the mandrel and the second portion of the mandrel so that the first portion of the mandrel contacts an inside surface of a first side of a case and so that the second portion of the mandrel contacts an inside surface of a second side of the case. In an example, the end-of-arm tool, additionally includes programming defined in one or more memory devices, to control operation of the end-of-arm tool, wherein the programming is configured for: providing a partial vacuum to a first suction cup of the first portion of the mandrel and to a second suction cup of the second portion of the mandrel; attaching the first and second suction cups to first and second minor flaps of a case, respectively; closing major flaps of the case; and releasing the partial vacuum to the first suction cup of the first portion of the mandrel and to the second suction cup of the second portion of the mandrel, to release the first and second minor flaps. In an example, the end-of-arm tool additionally includes programming defined in one or more memory devices, to control operation of the end-of-arm tool, wherein the programming is configured for: separating the first portion of the mandrel from the second portion of the mandrel so that the first portion of the mandrel contacts an inside surface of a first side of a case, and so that the second portion of the mandrel contacts an inside surface of a second side of the case; folding first and second flaps of the case; providing partial vacuum to a first suction cup of the first portion of the mandrel, and to a second suction cup of the second portion of the mandrel, to respectively attach to the first and second flaps of the case; sealing third and fourth flaps of the case; releasing the first suction cup of the first portion of the mandrel and the second suction cup of the second portion of the mandrel; and reducing separation of the first portion of the mandrel and the second portion of the mandrel prior to fully withdrawing the first and second portions of the mandrel from the case.

In a second example, an end-of-arm tool for attachment to a robotic arm, the end-of-arm tool includes: a mandrel configured to move between a retracted state and an extended state, wherein the retracted state is sized for insertion of the mandrel into a case, and wherein in the extended state the mandrel is sized to contact an inner surface of a first side of the case and an inner surface of a second side of the case; a base configured with an attachment point and configured to move portions of the mandrel between the retracted state and the extended state; and at least two suction cups, carried by the mandrel, and configured for releasable attachment to first and second flaps of the case when the mandrel is in the extended state. In an example, the mandrel includes: a first portion; a second portion; and a linkage, connecting the first portion of the mandrel and the second portion of the mandrel, to move the first portion of the mandrel and the second portion of the mandrel in a unified manner. In an example, the end-of-arm tool for attachment to a robotic arm additionally includes programming, to control operation of the end-of-arm tool, wherein the programming is configured to: move and separate a first portion of the mandrel and a second portion of the mandrel so that the first portion of the mandrel contacts an inside surface of a first side of a case and so that the second portion of the mandrel contacts an inside surface of a second side of the case. In an example, the end-of-arm tool for attachment to a robotic arm additionally includes programming defined in one or more memory devices, to control operation of the end-of-arm tool, wherein the programming is configured for: providing suction to a suction cup of a first portion of the mandrel and to a suction cup of a second portion of the mandrel, to attach to first and second opposed flaps of a case, respectively, prior to closing of third and fourth opposed flaps of the case; and releasing the suction to the suction cup of the first portion of the mandrel and to the suction cup of the second portion of the mandrel, to release the first and second opposed flaps, respectively, after the third and fourth opposed flaps of the case are closed. In an example, the end-of-arm tool for attachment to a robotic arm additionally includes programming defined in one or more memory devices, to control operation of the end-of-arm tool, wherein the programming is configured for: separating a first portion of the mandrel from a second portion of the mandrel so that the first portion of the mandrel contacts an inside surface of a first side of a case and so that the second portion of the mandrel contacts an inside surface of a second side of the case; attaching a first suction cup of the first portion of the mandrel and a second suction cup of the second portion of the mandrel to respective first and second opposed minor flaps of the case; releasing the first suction cup of the first portion of the mandrel and the second suction cup of the second portion of the mandrel from respective first and second opposed minor flaps of the case after third and fourth opposed major flaps have been folded; and reducing separation of the first portion of the mandrel and the second portion of the mandrel prior to fully withdrawing the first and second portions of the mandrel from the case.

In a third example, an end-of-arm tool for attachment to a robotic arm, includes: a first mandrel, configured to be extended to contact an inside surface of a first side of a case; a second mandrel, configured to be extended to contact an inside surface of a second side of the case; and a base to which the first mandrel and the second mandrel are attached, wherein the base supports the first mandrel and the second mandrel by a distance that is adjustable. In an example, the end-of-arm tool for attachment to a robotic arm, wherein with the first mandrel and the second mandrel configured in an extended state, the case is held in a square configuration. In an example, of the end-of-arm tool for attachment to a robotic arm, with the first mandrel and the second mandrel configured in an extended state, first and second suction cups of the first and second mandrels are positioned to secure first and second minor flaps, respectively, of the case in a closed state. In an example, the end-of-arm tool for attachment to a robotic arm: the first mandrel and the second mandrel, when in an extended state, are configured to hold minor flaps of the case a closed state; and the first mandrel and the second mandrel, when in an extended state, are configured to press the minor flaps against first and second major flaps. In an example, the end-of-arm tool for attachment to a robotic arm additionally includes programming defined in one or more memory devices, to control operation of the end-of-arm tool, wherein the programming is configured to: move and separate the first mandrel and the second mandrel so that the first mandrel contacts an inside surface of a case and so that the second mandrel contacts an inside surface of the case. In an example, the end-of-arm tool for attachment to a robotic arm additionally includes programming defined in one or more memory devices, to control operation of the end-of-arm tool, wherein the programming is configured for: connecting a first suction cup of the first mandrel and a second suction cup of the second mandrel to a low-pressure source; attaching first and second minor flaps of a case to the first and second suction cups, respectively; closing of major flaps of the case; and releasing suction to the first and second suction cups, to release first and second minor flaps, respectively. In an example, the end-of-arm tool for attachment to a robotic arm, additionally includes programming defined in one or more memory devices, to control operation of the end-of-arm tool, wherein the programming is configured for: separating the first mandrel from the second mandrel so that the first mandrel contacts an inside surface of a trailing side of a case and so that the second mandrel contacts an inside surface of a leading side of the case; attaching a first suction cup of the first mandrel and a second suction cup of the second mandrel to first and second minor flaps of the case; releasing the first suction cup and the second suction cup from the first and second minor flaps of the case, respectively, after major flaps of the case have been plowed; reducing separation of the first mandrel and the second mandrel; and withdrawing the end-of-arm tool from the case.

In a fourth example, an end-of-arm tool may have a fixed-size mandrel and/or jig. The end-of-arm tool may be attached to a fixed-size mandrel, including two or more suction cups configured and located to grasp opposed flaps of a case; a base to which fixed-size mandrel is attached; and an attachment point defined on the base, to allow attachment of the base to a robotic arm.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. An end-of-arm tool, comprising:
a mandrel, comprising:
a first portion; and
a second portion;
a base to which the first portion of the mandrel and the second portion of the mandrel are attached in an adjustable manner to allow a distance between the first portion of the mandrel and the second portion of the mandrel to be adjusted; and
an attachment point.

2. The end-of-arm tool as recited in claim 1, wherein:
the attachment point is configured to allow connection to a robotic arm.

3. The end-of-arm tool as recited in claim 1, wherein:
the distance between the first portion of the mandrel and the second portion of the mandrel is adjustable to allow the first portion of the mandrel to contact an inside surface of a first side of a case, and to allow the second portion of the mandrel to contact an inside surface of a second side of the case.

4. The end-of-arm tool as recited in claim 1, additionally comprising:
at least one suction cup carried by each of the first portion of the mandrel and the second portion of the mandrel.

5. The end-of-arm tool as recited in claim 1, additionally comprising:
a linkage, connecting the first portion of the mandrel and the second portion of the mandrel, to move the first portion of the mandrel and the second portion of the mandrel in a unified manner.

6. The end-of-arm tool as recited in claim 1, additionally comprising programming defined in one or more memory devices, to control operation of the end-of-arm tool, wherein the programming is configured for:
moving and separating the first portion of the mandrel and the second portion of the mandrel so that the first portion of the mandrel contacts an inside surface of a first side of a case and so that the second portion of the mandrel contacts an inside surface of a second side of the case.

7. The end-of-arm tool as recited in claim 1, additionally comprising programming defined in one or more memory devices, to control operation of the end-of-arm tool, wherein the programming is configured for:
providing a partial vacuum to a first suction cup of the first portion of the mandrel and to a second suction cup of the second portion of the mandrel;
attaching the first and second suction cups to first and second minor flaps of a case, respectively;
closing major flaps of the case; and
releasing the partial vacuum to the first suction cup of the first portion of the mandrel and to the second suction cup of the second portion of the mandrel, to release the first and second minor flaps.

8. The end-of-arm tool as recited in claim 1, additionally comprising programming defined in one or more memory devices, to control operation of the end-of-arm tool, wherein the programming is configured for:
separating the first portion of the mandrel from the second portion of the mandrel so that the first portion of the mandrel contacts an inside surface of a first side of a case, and so that the second portion of the mandrel contacts an inside surface of a second side of the case;
folding first and second flaps of the case;
providing partial vacuum to a first suction cup of the first portion of the mandrel, and to a second suction cup of the second portion of the mandrel, to respectively attach to the first and second flaps of the case;
sealing third and fourth flaps of the case;
releasing the first suction cup of the first portion of the mandrel and the second suction cup of the second portion of the mandrel; and
reducing separation of the first portion of the mandrel and the second portion of the mandrel prior to fully withdrawing the first and second portions of the mandrel from the case.

9. An end-of-arm tool for attachment to a robotic arm, the end-of-arm tool comprising:
a mandrel configured to move between a retracted state and an extended state, wherein the retracted state is sized for insertion of the mandrel into a case, and wherein in the extended state the mandrel is sized to contact an inner surface of a first side of the case and an inner surface of a second side of the case;
a base configured with an attachment point and configured to move portions of the mandrel between the retracted state and the extended state; and
at least two suction cups, carried by the mandrel, and configured for releasable attachment to first and second flaps of the case when the mandrel is in the extended state.

10. The end-of-arm tool for attachment to the robotic arm as recited in claim 9, wherein the mandrel comprises:
a first portion;
a second portion; and
a linkage, connecting the first portion of the mandrel and the second portion of the mandrel, to move the first portion of the mandrel and the second portion of the mandrel in a unified manner.

11. The end-of-arm tool for attachment to the robotic arm as recited in claim 9, additionally comprising programming, to control operation of the end-of-arm tool, wherein the programming is configured to:
move and separate a first portion of the mandrel and a second portion of the mandrel so that the first portion of the mandrel contacts an inside surface of a first side of a case and so that the second portion of the mandrel contacts an inside surface of a second side of the case.

12. The end-of-arm tool for attachment to the robotic arm as recited in claim 9, additionally comprising programming defined in one or more memory devices, to control operation of the end-of-arm tool, wherein the programming is configured for:
providing suction to a suction cup of a first portion of the mandrel and to a suction cup of a second portion of the mandrel, to attach to first and second opposed flaps of a case, respectively, prior to closing of third and fourth opposed flaps of the case; and
releasing the suction to the suction cup of the first portion of the mandrel and to the suction cup of the second portion of the mandrel, to release the first and second opposed flaps, respectively, after the third and fourth opposed flaps of the case are closed.

13. The end-of-arm tool for attachment to the robotic arm as recited in claim 9, additionally comprising programming defined in one or more memory devices, to control operation of the end-of-arm tool, wherein the programming is configured for:
separating a first portion of the mandrel from a second portion of the mandrel so that the first portion of the mandrel contacts an inside surface of a first side of a case and so that the second portion of the mandrel contacts an inside surface of a second side of the case;
attaching a first suction cup of the first portion of the mandrel and a second suction cup of the second portion of the mandrel to respective first and second opposed minor flaps of the case;
releasing the first suction cup of the first portion of the mandrel and the second suction cup of the second portion of the mandrel from respective first and second opposed minor flaps of the case after third and fourth opposed major flaps have been folded; and
reducing separation of the first portion of the mandrel and the second portion of the mandrel prior to fully withdrawing the first and second portions of the mandrel from the case.

14. An end-of-arm tool for attachment to a robotic arm, comprising:
a first mandrel, configured to be extended to contact an inside surface of a first side of a case;
a second mandrel, configured to be extended to contact an inside surface of a second side of the case; and
a base to which the first mandrel and the second mandrel are attached, wherein the base supports the first mandrel and the second mandrel by a distance that is adjustable.

15. The end-of-arm tool for attachment to the robotic arm as recited in claim 14, wherein with the first mandrel and the second mandrel configured in an extended state, the case is held in a square configuration.

16. The end-of-arm tool for attachment to the robotic arm as recited in claim 14, wherein with the first mandrel and the second mandrel configured in an extended state, first and second suction cups of the first and second mandrels are positioned to secure first and second minor flaps, respectively, of the case in a closed state.

17. The end-of-arm tool for attachment to the robotic arm as recited in claim 14, wherein:
the first mandrel and the second mandrel, when in an extended state, are configured to hold minor flaps of the case a closed state; and
the first mandrel and the second mandrel, when in an extended state, are configured to press the minor flaps against first and second major flaps.

18. The end-of-arm tool for attachment to the robotic arm as recited in claim 14, additionally comprising programming defined in one or more memory devices, to control operation of the end-of-arm tool, wherein the programming is configured to:
move and separate the first mandrel and the second mandrel so that the first mandrel contacts an inside surface of a case and so that the second mandrel contacts an inside surface of the case.

19. The end-of-arm tool for attachment to the robotic arm as recited in claim 14, additionally comprising programming defined in one or more memory devices, to control operation of the end-of-arm tool, wherein the programming is configured for:
connecting a first suction cup of the first mandrel and a second suction cup of the second mandrel to a low-pressure source;
attaching first and second minor flaps of a case to the first and second suction cups, respectively;
closing of major flaps of the case; and
releasing suction to the first and second suction cups, to release first and second minor flaps, respectively.

20. The end-of-arm tool for attachment to the robotic arm as recited in claim 14, additionally comprising programming defined in one or more memory devices, to control operation of the end-of-arm tool, wherein the programming is configured for:
separating the first mandrel from the second mandrel so that the first mandrel contacts an inside surface of a trailing side of a case and so that the second mandrel contacts an inside surface of a leading side of the case;
attaching a first suction cup of the first mandrel and a second suction cup of the second mandrel to first and second minor flaps of the case;
releasing the first suction cup and the second suction cup from the first and second minor flaps of the case, respectively, after major flaps of the case have been plowed;
reducing separation of the first mandrel and the second mandrel; and
withdrawing the end-of-arm tool from the case.
